(19) United States
(12) Patent Application Publication
(10) Pub. No.: US 2008/0145499 A1
(43) Pub. Date: Jun. 19, 2008

(54) Method for treating fruit or vegetables with phosphorous ions and corresponding compositions

(76) Inventor: Alberto Sardo, Chateaurenard (FR)

Correspondence Address: WENDEROTH, LIND & PONACK, L.L.P., 2033 K STREET N. W., SUITE 800, WASHINGTON, DC, 20006-1021, US

(21) Appl. No.: 11/987,982

(22) Filed: Dec. 6, 2007

(30) Foreign Application Priority Data
Dec. 7, 2006 (FR) 06 10688

(51) Int. Cl. A23L 3/358; A01N 59/26; A01P 3/00

(52) U.S. Cl. 426/335; 424/605

(57) ABSTRACT

The present application relates to a new method for treating fruit or vegetables comprising the use of hot phosphorous acid (PA) as well as PA-based combinations and corresponding kits.

### TECHNICAL FIELD OF THE INVENTION

The present invention relates to a method for treating fruit or vegetables. It is essential that the fruit and vegetables do not lose their organoleptic quality and maintain an attractive appearance when they are put on the market so as to be bought quickly. Once harvested, however, fruit and vegetables are currently stored for relatively long periods before being put on the market. The appearance and taste of the fruit and vegetables are likely to be altered, in particular, by the spreading of fungi and bacteria on their surface. Such spoilage occurs even more quickly if tiny bruises and cuts appear on the skin during storage or handling of the fruit and vegetables. The fruit and vegetables are also likely to be damaged by scald which is evident by a blackening of the skin of affected fruit and vegetables.

### BACKGROUND TO THE INVENTION

Phosphonic acid (H—PO₃H₂) (PA) is also known as phosphorous acid (H₃PO₃). This compound has a fungicidal activity similar to that of Fosetyl-Al (aluminium ethyl phosphonate). Within hours, the compound breaks down into PA in plant tissues.

PA activity is known, above all, on mildews (phycomycetes). In contrast, PA has little effect with regard to imperfect ascomycetes and fungi which are parasites of fruit and vegetables (Fusarium spp., Botrytis sp., Phlyctema sp., Penicillium spp., etc.).

Attempts have, however, been made to apply PA (or Fosetyl-Al) post-harvest. Maximum residue limits (MRL) (expressed in PA) after culture treatment are close to 50 ppm: therefore, treatment could take place post-harvest with relatively high doses. By way of comparison, the MRL of Pyrimethanil is (currently) only 0.3 ppm.

Unfortunately, at ambient temperature, activity is very weak, in particular on Penicilliums, even with treatment doses close to 10,000 ppm in the case of Penicilliums in oranges.

The present inventors unexpectedly combined PA with thermotherapy, i.e. a treatment with hot water at a temperature bordering on 50° C. Against all expectations the results were excellent in that they demonstrated potentiation of PA activity.

Generally, the level of efficacy obtained with reduced doses, up to ⅕ of the dose of PA used at ambient temperature, is the same, if not greater. On the whole, the amount of residues decreased.

### SUMMARY OF THE INVENTION

The present invention therefore relates to a method for treating fruit or vegetables with hot PA. The method herein has a synergistic effect, particularly with PA doses of less than 10,000 ppm. This synergy is observed particularly with Penicilliums. The method according to the invention is therefore particularly suited to post-harvest treatment.

According to a first aspect, the present invention thus relates to a method for treating fruit or vegetables comprising use of a hot phosphorous acid-based treatment composition, preferably at a temperature of between 30° and 60° C., preferably between 40° and 60° C. and even more preferably between 45° and 55° C., in particular between 48° and 52° C., for example 50° C.

According to another preferred aspect, the fruit or vegetables are in contact with the treatment solution for between 10 seconds and 10 minutes.

The treatment composition may be applied by any method known per se, in particular by spraying or immersing the fruit or vegetables with or in the treatment solution kept at the desired temperature; the fruit and vegetables can therefore be treated whilst they are stored in crates or pallets or even when they are out of the crates or pallets before they are marketed, as is the case with oranges for example.

More preferably, when the fruit and vegetables in crates or pallets are treated by immersion, the treatment composition may be applied by means of a device as disclosed in application FR 01 096 27. The device is particularly advantageous because it allows the hot solution to be evenly applied to the fruit and vegetables stored on a pallet or in a crate.

Generally, fruit and vegetables are stored in covered crates/pallets. The bases, lateral walls and covers of said crates/pallets are pierced in order to allow the treatment composition to soak the fruit or vegetables to be treated.

When the fruit or vegetables contained in a crate/pallet are completely immersed, they collect either at the bottom of the crate/pallet (if they are more dense than the aqueous treatment composition) or beneath the cover of the crate/pallet (if they are less dense than the aqueous treatment composition). In any case, it is acknowledged that, after the treatment process, the contact points between the fruit and vegetables will not have been treated.

Application FR 01 09 627 solves this problem by providing a method which allows the surface of the fruit or vegetables to be treated more evenly. This method, incorporated herein by reference, is described in more detail hereinafter and in FIGS. 1 to 3.

It comprises the following steps:
providing a bath containing a treatment composition 12,
placing the fruit or vegetables 3 in the retention means 4,
lowering the retention means 4 so the fruit or vegetables 3 are completely immersed in the bath,
raising the retention means 4 so the fruit or vegetables are completely removed from the bath,

and, after the fruit or vegetables 3 have been completely immersed and before they have been removed from the bath, it comprises the following intermediate steps:
raising the retention means 4 so the fruit or vegetables 3 contained therein emerge at least in part from the bath, and
lowering the retention means 4 so the fruit or vegetables 3 contained therein are once again completely immersed in the bath.

Preferably, the intermediate steps are repeated in a cycle which lasts between 2 seconds and 2 minutes.

This method is particularly suitable for carrying out the method for treating fruit or vegetables with phosphorous acid by means of a hot treatment composition 12, preferably at a temperature of between 30° and 60° C., preferably between 40° and 60° C. and even more preferably between 45° and 55° C., in particular between 48° and 52° C., for example 50° C.

According to another preferred aspect, the treatment composition is denser than the fruit or vegetables to be treated and, during the intermediate step of raising the retention means 4, the weight of the emerging fruit or vegetables 3 is greater than the push exerted on the fruit or vegetables 3 still immersed in accordance with Archimedes' theory.

Thus, the treatment composition 12 may further comprise an agent for increasing its density, such as an alkaline metal silicate, an alkaline metal phosphate, an alkaline metal bicarbonate, an alkaline metal carbonate or an alkaline metal sulphonate. In particular, a potassium phosphate such as potassium pyrophosphate or potassium metaphosphate is preferred.

Advantageously, according to the invention, the fruit or vegetables 3 are completely immersed in the treatment composition for less than 10 minutes.

According to another object, the present invention also relates to the kit allowing the treatment composition to be applied to the fruit and vegetables. Said kit comprises the system disclosed in application FR 01 09 627 with the phosphorous acid-based treatment composition according to the present invention.

The kit according to the invention thus comprises:

i) a system comprising:
means for packaging the fruit or vegetables in the retention means 4,
means 16 for forming a bath containing a treatment composition 12,
means 18 for lowering and raising the retention means 4, and
a unit for controlling the lowering and raising means 18 adapted, on the one hand, for controlling the following steps:
lowering the retention means 4 so the fruit and vegetables 3 contained therein are completely immersed in the bath, and
raising the retention means 4 so the fruit or vegetables 3 are completely removed from the bath, and, on the other hand, for controlling, between these two steps, the following intermediate steps:
raising the retention means 4 so the fruit or vegetables 3 contained therein emerge at least in part from the bath, and
lowering the retention means 4 so the fruit and vegetables 3 contained therein are once again completely immersed in the bath:

and

ii) a phosphorous acid-based treatment composition 12, said treatment composition having a temperature of between 30° and 60° C., preferably between 40° and 60° C. and even more preferably between 45° and 55° C., in particular between 48° and 52° C., for example 50° C. according to the invention.

According to another advantageous aspect, when the fruit and vegetables stored in crates or pallets are treated by spraying, the following method is carried out, comprising the following steps:
collecting packaging means containing the fruit or vegetables into a block which is substantially compact in a housing delimited by a band of lateral walls inside a chamber, the lateral walls extending in a longitudinal direction, at least one of the lateral walls being deformable between a block engagement configuration and a block release configuration,
bringing the or each deformable lateral wall into its block engagement configuration, and
longitudinally flowing a treatment composition at a temperature of between 30° and 60° C. through the housing at a flow rate of between 20 and 150 m³/m²/h and for a duration of between 10 seconds and 10 minutes.

Preferably, the flow rate is between 50 and 100 m³/m²/h and the duration is between 1 and 5 minutes.

The corresponding kit for implementation of the method comprises:
a chamber comprising a band of lateral walls extending in a longitudinal direction, the band delimiting, inside the chamber, a housing for receiving the fruit or vegetables to be treated, at least one of the lateral walls being deformable between a configuration for engaging and a configuration for releasing a load arranged inside the housing,
a device for feeding treatment composition into the chamber and for removing treatment composition from the chamber,
means for heating the treatment composition, and
a system for deforming the deformable walls.

and

ii) a phosphorous acid-based composition, said treatment composition having a temperature of between 30° and 60° C., preferably between 40° and 60° C. and even more preferably between 45° and 55° C., in particular between 48° and 52° C., for example 50° C., is thus also part of the present invention.

Preferably, said walls are inflatable walls.

According to another advantageous aspect, the concentrations of phosphorous acid in the treatment composition are between 200 ppm and 10,000 ppm, preferably between 500 ppm and 5,000 ppm, more preferably between 2,000 and 4,000 ppm.

The amount of product applied depends on the amount of fruit and vegetables to be treated as well as the storage conditions and the level of maturity of stored fruit and vegetables and/or the level of maturity desired. Generally, between 3,000 and 10,000 litres of treatment composition at the concentrations indicated above are applied for every 100 to 300 tons of fruit and vegetables to be treated.

According to another advantageous aspect, the treatment composition according to the invention comprises another fungicide, in addition to phosphorous acid. Preferably, said fungicide is selected from all fungicides conventionally used for treating fruit or vegetables, in particular fungicides which are applied post-harvest. In particular, eugenol, isoeugenol or a salt thereof, thiabendazole (TBZ), ortho-phenylphenol, imazalil or imazalil phosphite may be mentioned.

Combinations comprising phosphorous acid with said fungicide conventionally used for treating fruit or vegetables are also part of the present invention. Preferably, the fungicide is selected from eugenol, isoeugenol or a salt thereof, TBZ, ortho-phenylphenol, imazalil or imazalil phosphite; in particular, eugenol, a eugenol salt which is acceptable in foodstuffs, isoeugenol, an isoeugenol salt acceptable in food stuffs and mixtures thereof are preferred.

The combinations according to the invention are particularly suited for use when hot, i.e. at a temperature of between 30° and 60° C., preferably between 40° and 60° C. and even more preferably between 45° and 55° C., in particular between 48° and 52° C., for example 50° C.

According to a preferred aspect, the fungicide is present at concentrations conventionally used. Thus, eugenol may be used at concentrations of between 300 and 4,500 ppm, imazalil at concentrations of between 100 and 1,000 ppm, ortho-phenylphenol at concentrations of between 500 and 3,000 ppm and TBZ at concentrations of between 100 and 1,000 ppm.

The phosphorous acid and the fungicide may be applied simultaneously or separately or in a sequenced manner over time.

The treatment compositions and the combinations according to the invention applied when hot give synergistic results with a wide range of strains, especially strains which characteristically appear post-harvest, in particular Penicilliums. Furthermore, the combinations according to the invention display significant activity on strains resistant to phosphorous acid.

According to the invention, “phosphorous acid” (or “phosphonic acid” or “phosphite”) means any compound which allows the release of a phosphite ion H₂PO₃⁻. Phosphonic acid (or HPO₃H₂), phosphorous acid (H₃PO₃) or even potassium phosphite, sodium phosphite, ammonium phosphite or magnesium phosphite may also be mentioned.

According to the invention, the expression “treatment composition” refers to a composition comprising phosphorous acid. Generally, the treatment composition is an aqueous solution.

Furthermore, the treatment compositions may also contain a fungicide within the scope of the combinations according to the invention.

The treatment compositions may also comprise any additive conventionally used, in particular for treating fruit or vegetables.

### BRIEF DESCRIPTION OF THE DRAWINGS

FIG. 1 is a lateral schematic view of a system for treating fruit or vegetables according to the invention;

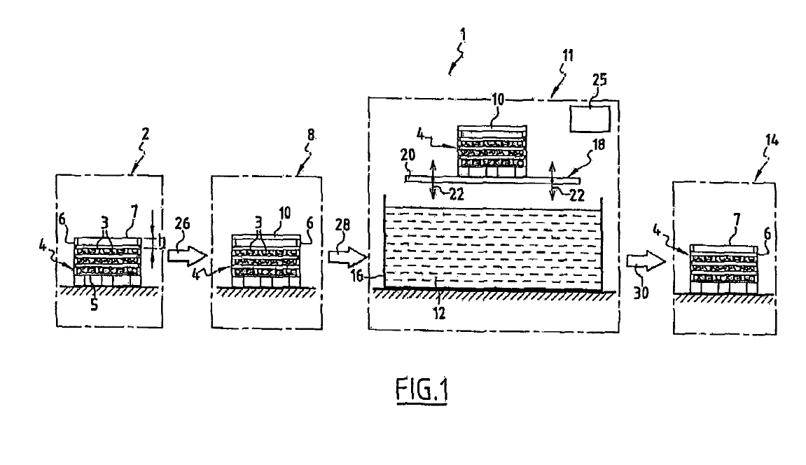

FIGS. 2 and 3 are enlarged partial lateral schematic views illustrating two successive intermediate steps of the method implemented by the system in FIG. 1.

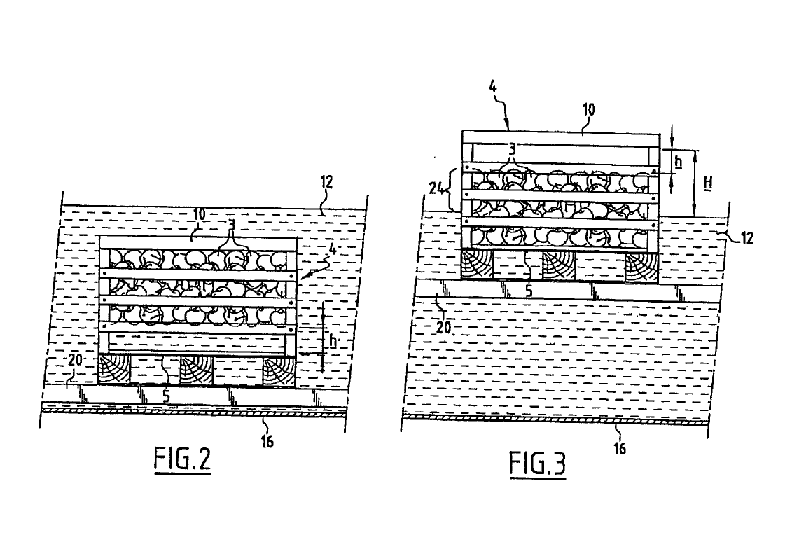

### DESCRIPTION OF PREFERRED EMBODIMENTS

The following examples are given to illustrate the invention and are not intended to be limiting.

### 1—In vitro Study of the Activity of Phosphonic Acid on P. expansum

As Table 1 shows, the activity of PA at ambient temperature is partial, even at 4,000 ppm.

The combination with thermotherapy considerably intensifies efficacy, even at 1,000 ppm.

TABLE 1
Efficacy of PA (in the form of “Kphos”) on
germination of P. expansum spores (22° C.)

| | Germinated spores | | |
|---|---|---|---|
| Treatment | | 24 hours | 48 hours |

| | | | | |
|---|---|---|---|---|
| Control | 100 | a | 100 | a |
| Control 50° C., 2 min | 85 | a | 93 | a |
| Phosphonic acid 1,000 ppm | 27 | b | 34 | b |
| Phosphonic acid 4,000 ppm | 11 | c | 11 | c |
| Phosphonic acid 1,000 ppm | 0 | d | 21 | c |
| 50° 2 min | | | | |
| Phosphonic acid 4,000 ppm | 0 | d | 0 | c |
| 50° 2 min | | | | |

The values followed by the same letter are not statistically different (test Student P = 0.05)
Kphos = phosphonic acid neutralised by KOH (pH 6.5).

### 2—In vivo Study of the Activity of Phosphonic Acid (Kphos) on P. expansum Infections in Apples

TABLE 2
Efficacy of PA (in the form of “Kphos”) on
the development of natural infections in organic
Elstar apples caused by P. expansum (2° C.)

| | % apples with symptoms | | | | | | | |
|---|---|---|---|---|---|---|---|---|
| | 2001-2002 * | | | | 2002-2003 * | | | |
| | 90 days | | 180 days | | 90 days | | 180 days | |
| Treatment | | | | | | | | |
| Control | 4.6 | a | 15.6 | a | 6.0 | a | 16.5 | a |
| Control 50° C. 2 min | 4.2 | a | 15.3 | a | 5.6 | a | 15.5 | a |
| PA 1,000 ppm | 3.1 | a | 13.1 | a | 4.9 | a | 11.1 | a |
| PA 1,000 ppm - 50° | 0.0 | b | 4.7 | b | 0.0 | b | 6.3 | c |
| C. 2 min | | | | | | | | |
| Chemical references | | | | | | | | |
| Pyrimethanil 250 | 4.1 | a | 16.2 | a | 4.0 | a | 19.0 | a |
| ppm | | | | | | | | |
| Pyrimethanil 500 | 3.2 | a | 21.3 | a | 0.0 | a | 14.0 | a |
| ppm | | | | | | | | |
| Fluidoxonil 200 ppm | 1.1 | b | 4.9 | b | 4.0 | a | 7.0 | c |

* number of days after treatment
Treatments given after 26 days of storage at 2° C.

Given the weak in vitro activity of PA at ambient temperature on P. expansum, it is not surprising that this experiment found the same to be true in vivo, that is to say an activity close to 0.

In contrast, in combination with thermotherapy, efficacy is comparable to and even greater than that of the best synthetic fungicides currently available.

### 3—Efficacy of PA and Thermotherapy on P. digitatum Infections in Oranges

TABLE 3
Activity of PA in combination with Bioxeda
and thermotherapy on Navel oranges

| | Oranges with symptoms | | |
|---|---|---|---|
| Treatments | | 9 days | 18 days |

| | | | | |
|---|---|---|---|---|
| Control | 95% | a | 100% | a |
| Control 48° C. 2 min | 45% | b | 83% | b |
| Bioxeda (1) 48° C. 2 min | 4% | b | 60% | b |
| Bioxeda + PA (2) 48° C. 2 min | 0% | b | 26% | c |

(1) - Bioxeda, active ingredient: eugenol 1.8 g/L
(2) - PA 1,000 ppm (“Kphos”)

In this experiment, the oranges were damaged then inoculated with P. Digitatum (500,000 sp/mL) and treated 15 hours later; they were stored at 5° C.

The complementary effect of PA was noticed at 9 days and, above all, at 18 days, when the rate of decay was 2.3 times lower in the presence of PA (26% in Bioxeda, 60% and 100% in the control).

### 4—Efficacy of PA on P. digitatum Infections in Oranges. Comparison with a Mixture of Three Fungicides. All Treatments Were Combined with Thermotherapy

TABLE 4
efficacy of PA combined with thermotherapy
on P. digitatum (Navel oranges). Comparison

| | | Oranges with symptoms | |
|---|---|---|---|
| | | 12 D 5 0C = 3 D SPC | |
| Treatments | Number of fruit | (1) | |
| Control | 200 | 9.0 | a |
| Thermotherapy + | 300 | 1.0 | b |
| imazalil 400 ppm + | | | |
| TBZ 450 ppm + | | | |
| OPP 1,500 ppm | | | |
| Thermotherapy + | 200 | 0.5 | b |
| phosphonic acid | | | |
| 2,000 ppm | | | |

(1) SPC: simulation of selling period was 3 days at ambient temperature.
TBZ: thiabendazole
OPP: ortho-phenylphenol.

This time, as Table 4 shows, the efficacy of PA on natural infections proved to be greater than or equivalent to the treatment applied with three fungicides conventionally used in cases of Penicillium decay in oranges.

### 5—Efficacy of PA on Natural P. digitatum Infections in Oranges Combined with Thermotherapy

A new experiment which took place under conditions very similar to those in real life was carried out: natural infections, storage in cold conditions, simulation of storage periods (SPC).

TABLE 5
Efficacy of phosphonic acid combined with thermotherapy
on P. digitatum in (Navel) oranges.

| | | % oranges with |
|---|---|---|
| | | symptoms 15 D 5° C. + 5 |
| Treatments | Number of fruit | D SPC |
| Control | 600 | 10.2% |
| Thermotherapy 50° C. 3 | 400 | 6.5% |
| min | | |
| PA 2,000 ppm | 400 | 6.0% |
| PA 4,000 ppm | 400 | 5.1% |
| Thermotherapy + PA | 300 | 4.0% |
| 2,000 ppm | | |
| Thermotherapy + PA | 300 | 2.7% |
| 4,000 ppm | | |

The table shows excellent efficacy of PA, in particular at 4,000 ppm, combined with thermotherapy (73.5%). No phytotoxicity was found, which implies that an increase in the concentration and therefore efficacy is still possible. With a residual solution on the fruit of 1.5 l/tonne at 4,000 ppm, i.e. 6 g/tonne, the amount of theoretical residue, approximately 6 ppm, would be very weak for this molecule. As MRLs are 50 ppm the dose could be increased if necessary.

### CONCLUSION

These different experiments show that thermotherapy potentiates, in a synergistic manner, the fungicidal effect of PA. It will be noted that the fungicides currently used generate strains with a high level of resistance which leads to low levels of defence against infections (such is the case with thiabendazole, carbendazim and imazalil in particular). However, there is no resistance with PA.

### 6—Activity of the Combinations According to the Invention

### 6.1. PA/Eugenol

Washington oranges inoculated with Penicillium digitatum came into contact with a eugenol/potassium phosphite solution containing 1,100 ppm of eugenol and 1,600 ppm of potassium phosphite for 2 minutes at 38° C. and 48° C. The treated fruit was kept at 7° C. and then examined after 9 and 18 days. The fruit was compared with fruit treated with only eugenol in the same conditions and with inoculated fruits that had not been treated.

The table below shows the percentages of decayed fruit:

| | After 9 days | After 18 days |
|---|---|---|
| 38° C. control | 95 | 100 |
| 48° C. Control | 68 | 90 |
| 38° C. eugenol | 12 | 73 |
| 48° C. eugenol | 4 | 60 |
| 38° C. potassium phosphite | 14 | 76 |
| 48° C. potassium phosphite | 3 | 44 |
| 38° C. eugenol/potassium | 11 | 68 |
| phosphite | | |
| 48° C. eugenol/potassium | 0 | 26 |
| phosphite | | |

These results show that an increase in temperature has a definite effect on the activity of eugenol and, above all, that this activity progresses strongly in the presence of phosphite at the same doses and for the same duration of contact.

### 6.2. PA/Imazalil

Valencia oranges inoculated with a strain of Penicillium digitatum resistant to imazalil were treated at 52° C. and were in contact for 2 minutes with:
300 ppm imazalil;
3,000 ppm potassium phosphite
the two products mixed in proportions of 300 ppm imazalil and 3,000 ppm potassium phosphite.

The results are shown in the following table:

| | | Number of | | | Average % |
|---|---|---|---|---|---|
| | | fruit | | % of | of |
| | Test | | un- | decayed | decayed |
| Treatments | number | decayed | affected | fruit | fruit |
| Inoculated | 1 | 10 | 0 | 100 | 100 |
| | 2 | 10 | 0 | 100 | |
| | 3 | 10 | 0 | 100 | |
| | 4 | 10 | 0 | 100 | |
| Control 52° C. | 1 | 7 | 3 | 70 | 85 |
| | 2 | 9 | 1 | 90 | |
| | 3 | 9 | 1 | 90 | |
| | 4 | 7 | 3 | 70 | |
| Potassium | 1 | 5 | 5 | 50 | 42.5 |
| phosphite 52° C. | 2 | 6 | 4 | 60 | |
| | 3 | 3 | 7 | 30 | |
| | 4 | 3 | 7 | 30 | |
| Imazalil 52° C. | 1 | 2 | 8 | 20 | 42.5 |
| | 2 | 7 | 3 | 70 | |
| | 3 | 3 | 7 | 30 | |
| | 4 | 5 | 5 | 50 | |
| Calcium phosphite + | 1 | 2 | 8 | 20 | 10 |
| imazalil 52° C. | 2 | 2 | 8 | 20 | |
| | 3 | 0 | 10 | 0 | |
| | 4 | 0 | 10 | 0 | |

As is evident from the table above, the rate of decay was halved when each product was applied individually (42.5% in contrast to 85%), whereas the rate of decay was 8.5 times lower with a combination of the two products.

These results clearly show the synergistic effect of the combinations according to the invention.

1. Method for treating fruit or vegetables comprising use of a phosphorous acid-based treatment composition at a temperature of between 30° and 60° C.

2. Method according to claim 1, wherein the composition further comprises a fungicide.

3. Method according to claim 1, wherein the fungicide is selected from eugenol, isoeugenol or a salt thereof, thiabendazole, ortho-phenylphenol, imazalil, or imazalil phosphite.

4. Method according to claim 2, wherein the phosphorous acid and the fungicide are applied simultaneously, separately or in a sequenced manner over time.

5. Method according to claim 1, wherein the treatment composition is at a temperature of between 40° and 60° C.

6. Method according to claim 1, wherein the treatment composition is at a temperature of between 45° and 55° C.

7. Method according to claim 1, wherein the fruit or vegetables are in contact with the treatment composition for between 10 seconds and 10 minutes.

8. Method according to claim 1, wherein the concentrations of phosphorous acid in the treatment composition are between 200 ppm and 10,000 ppm.

9. Method according to claim 1, wherein the concentrations of phosphorous acid in the treatment composition are between 500 ppm and 5,000 ppm.

10. Method according to claim 1, wherein the concentrations of phosphorous acid in the treatment composition are between 2,000 and 4,000 ppm.

11. Method according to claim 1, wherein the treatment composition is applied in a proportion of 3,000 to 10,000 litres of treatment composition for every 100 to 300 tons of fruit and vegetables to be treated.

12. Method according to claim 1, wherein the treatment composition is applied to the fruit and vegetables whilst they are in crates/pallets or when they are out of crates/pallets.

13. Method according to claim 1, wherein the treatment composition is applied by spraying or immersion.

14. Method according to claim 1 comprising the following steps:
providing a bath containing a phosphorous acid-based treatment composition at a temperature of between 30° and 60° C.,
placing the fruit or vegetables in the retention means,
lowering the retention means so the fruit or vegetables are completely immersed in the bath,
raising the retention means so the fruit or vegetables are completely removed from the bath,
and, after the fruit or vegetables have been completely immersed and before they have been removed from the bath, comprising the following intermediate steps:
raising the retention means so the fruit or vegetables contained therein emerge at least in part from the bath, and
lowering the retention means so the fruit or vegetables contained therein are once again completely immersed in the bath.

15. Method according to claim 14, wherein the fruit or vegetables are completely immersed in the treatment composition for a total time of less than 10 minutes.

16. Combination comprising phosphorous acid and a fungicide at a temperature of between 30° and 60° C.

17. Combination according to claim 16, wherein the fungicide is selected from eugenol, isoeugenol or a salt thereof, thiabendazole, ortho-phenylphenol, imazalil or imazalil phosphite.

18. Combination according to claim 16, wherein the phosphorous acid and the fungicide are applied simultaneously, separately or in a sequenced manner over time.

19. Kit comprising:
i) a system comprising:
means for packaging the fruit or vegetables in the retention means,
means for forming a bath containing a treatment composition of phosphorous acid at a temperature of between 30° and 60° C.,
means for lowering and raising the retention means, and
a unit for controlling the lowering and raising means which is adapted, on the one hand for controlling the following steps:
lowering the retention means so the fruit or vegetables contained therein are completely immersed in the bath, and
raising the retention means so the fruit or vegetables are completely removed from the bath, and, on the other hand, for controlling, between these two steps, the following intermediate steps:
raising the retention means so the fruit or vegetables contained therein emerge at least in part from the bath, and
lowering the retention means so the fruit or vegetables contained therein are once again completely immersed in the bath;
and
ii) a phosphorous acid treatment composition at a temperature of between 30° and 60° C.
